(19) United States
(12) Patent Application Publication
(10) Pub. No.: US 2023/0405798 A1
(43) Pub. Date: Dec. 21, 2023

(54) ROTATABLE TOOL ORGANIZER

(71) Applicants: Dennis Brouwer, Purcellville, VA (US); Rebecca Brouwer, Purcellville, VA (US)

(72) Inventors: Dennis Brouwer, Purcellville, VA (US); Rebecca Brouwer, Purcellville, VA (US)

(21) Appl. No.: 17/807,564

(22) Filed: Jun. 17, 2022

(51) Int. Cl. B25H 3/02; A45C 11/24; A45C 13/02; A45C 15/06; B25H 3/06

(52) U.S. Cl. CPC B25H 3/025; A45C 11/24; A45C 13/02; A45C 15/06; B25H 3/06; A45C 2011/002

(57) ABSTRACT

A tool organizer with a rotatable platform mounted on a supporting base, a post extending vertically from a center of the base and through a center of the rotatable platform, and a mobile phone holder extending from the tool organizer via an arm, configured to accommodate a mobile phone. The tool organizer also includes at least one vertical divider radially extending from the post and at least one horizontal shelf radially extending from the post.

### BACKGROUND OF THE INVENTION

The present invention relates to tool organizers and, more particularly, to a rotatable tool organizer.

Currently, tool boxes and tool bags are primary used for holding tools, supplies and materials. Often, the tool box is a repurposed container such as a bucket or box. These are inconvenient to access and difficult to keep organized. These inefficiencies are often exposed on a job site when completing a project and lead to frustration and additional time to complete the project.

In addition to its immediate impact on global public health, the Covid-19 pandemic, in conjunction with its enforced isolation, hugely disrupted commerce and nearly all other “routine” activities. One impact of this isolation is that individuals who own homes, cars, equipment, and machinery have been forced to attempt their own repairs and upgrades, frequently with a mishmash of tools and supplies, and more often than not, guided by an on-line tutorial or checklist. The explosive growth in Do-It-Yourself home repairs driven by Covid-19 has exposed the need for an individual to simultaneously (and safely) view tutorial videos while accessing tools and supplies at the project site.

Current tool organizers lack an ability to hold a cell phone for reference when completing a project. Current cell phone holders are tripods that are prone to tipping.

As can be seen, there is a need for a tool organizer that is easy to access, keep organized, and provides a way of holding a cell phone in a stationary, secure, and easily viewable fashion.

### SUMMARY OF THE INVENTION

In one aspect of the present invention, a tool organizer comprises a rotatable platform mounted on a supporting base, a post extending vertically from a center of the base and through a center of the rotatable platform, a mobile phone holder extending from the tool organizer via an arm, configured to accommodate a mobile phone, at least one vertical divider radially extending from the post, and at least one horizontal shelf radially extending from the post.

In another aspect of the present invention, a method of using a tool organizer comprises selecting from a group consisting of: tools, materials, supplies, and a combination thereof, placing the selection on a rotatable tool organizer with at least one horizontal shelf, at least one vertical divider, and a cell phone holder, inserting a cell phone into the cell phone holder, positioning the tool organizer in a location adjacent to a project, and rotating the tool organizer for access to the selection when completing the project.

These and other features, aspects and advantages of the present invention will become better understood with reference to the following drawings, description, and claims.

### BRIEF DESCRIPTION OF THE DRAWINGS

FIG. 1 is a perspective view of a rotatable tool organizer shown in use according to an embodiment of the present invention;

FIG. 2 is a front perspective view thereof;

FIG. 3 is a rear perspective view thereof;

FIG. 4 is a front view thereof;

FIG. 5 is a rear view thereof;

FIG. 6 is a top view thereof; and

FIG. 7 is a sectional view taken on line 7-7 of FIG. 6.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims with reference to the drawings.

A general overview of the various features of the invention will be provided, with a detailed description following. Broadly, an embodiment of the present invention provides a rotatable tool organizer with various shelves and compartments. Some embodiments may provide a stationary platform.

The present invention may enable convenient access to frequently used tools and materials as well as simultaneous hands-free access to a mobile phone.

The purpose of the present invention is to serve as a productivity aid for individuals working on projects, such as various handyman jobs for a household or business. The present invention may comprise a rotatable platform, a non-rotatable supporting base, and a mobile phone holder on a non-rotating platform.

In some embodiments, the present invention is a pyramidal, rotatable platform, or carousel, with a stationary supporting base, and cell phone holder. It may be approximately 24 inches tall and 18 inches in diameter at a base. The height and diameter of the present invention are not particularly limited as the height and diameter may vary.

The rotatable platform may comprise multiple shelves, positioned at varying heights, separated by dividers of varying heights. There may be at least one horizontal shelf and at least one vertical divider. The shelves and dividers may radially extend from a center of the tool organizer or a post at a center of the tool organizer. An arrangement and positioning of the shelves and dividers may form various compartments for the storage and organization of objects.

The invention may comprise a rotatable platform, or carousel, mounted on the base. The base may be a turntable. An axle may extend from the base up through a center of the carousel. The axle may be non-rotatable.

In some embodiments, the carousel may be a molded plastic, and the base and axle may be metal. In other embodiments, the base and carousel are made of wood.

The rotating tool carousel may have various compartments or shelves for storing various tools, materials, supplies or a combination thereof needed for a project, including but not limited to, power tools, hand tools, zip ties, tape, lubricants, solvents, chemicals, paper towels, and hand cleaner. The rotating carousel enables single-handed, easy, and convenient access to objects stored on it as a user may rotate the carousel to access the various objects.

A mobile phone may attach to the mobile phone holder or may be configured to accommodate a mobile phone. The mobile phone holder may be joined to the rotatable platform by an arm. The arm may be adjustable or extendable.

The mobile phone may display “how to” videos and project checklists available on-line to assist the user in a project. The phone holder may display do-it-yourself (DIY) videos, project checklists, images, or other resources intended to assist a user in completing a project.

In some embodiments of the present invention, a light may be attached next to the mobile phone holder. Said may extend from the device by an adjustable and/or extendable arm. The light may be a light emitting diode (LED) light.

An attachment device, alternatively a hanging point, may be at a top of the device. Said attachment device may be operative to hanging the present invention from a ceiling, ladder, or bracket. In some embodiments of the present invention, the attachment device may be an eye bolt. The attachment device may be used to secure the device in a non-work bench setting where space is limited, or the environment is not appropriate for a conventional steel toolbox. Said environments may include but are not limited to campgrounds, sailboats, and construction sites.

In some embodiments of the present invention, at least one stationary foot protrudes from a bottom of the non-rotating base.

The device may further comprise magnets to store or retain objects stored in the device or for further organization and securement of the objects.

The device may further comprise hooks, clips, apertures, fasteners, mounted compartments, or other means suitable for storing, retaining, organizing, or securing objects stored in the device.

A pyramidal or conical shape of the device may improve access to tools by the user and minimize tipping hazards.

In some embodiments of the present invention, the device may have caster wheels on a bottom of the device. Said caster wheels may be low profile. Such an embodiment may be approximately 12 inches in height. The present invention may be utilized under a vehicle and slide under a vehicle.

A user may utilize the invention with the following method steps. The user may select frequently used or project-specific objects such as tools, materials and/or supplies and load said objects onto the device. The user may place the device in a convenient location, such as adjacent to a project site or workbench. The user may insert their cell phone into the cell phone holder and display a desired video or information, such as a checklist, related to the user's project. The cell phone may also emit audio. Alternatively, the user may utilize the cell phone for entertainment such as for music or a podcast. The user may then work on completing a project. While completing said project, the user may access objects stored on the device by rotating the device and receive guidance for completing the device from cell phone. The user may utilize voice commands to stop, play, pause, or rewind a video playing on the cell phone. Upon completion of the project, the user may store all tools back on the device, remove the cell phone from the cell phone holder, and have a clean and tidy project site.

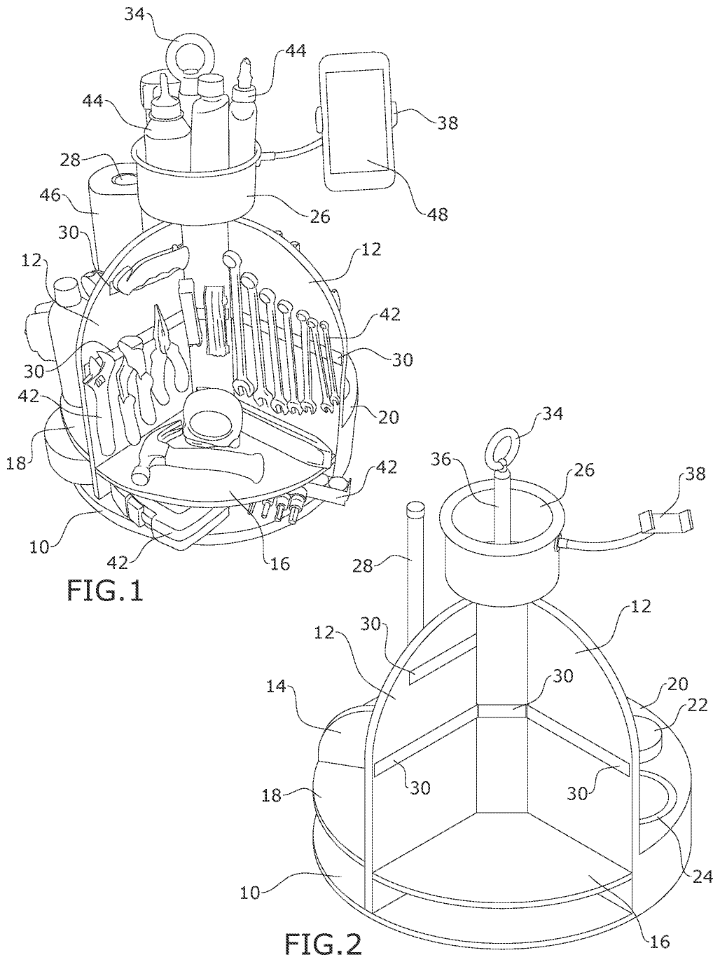

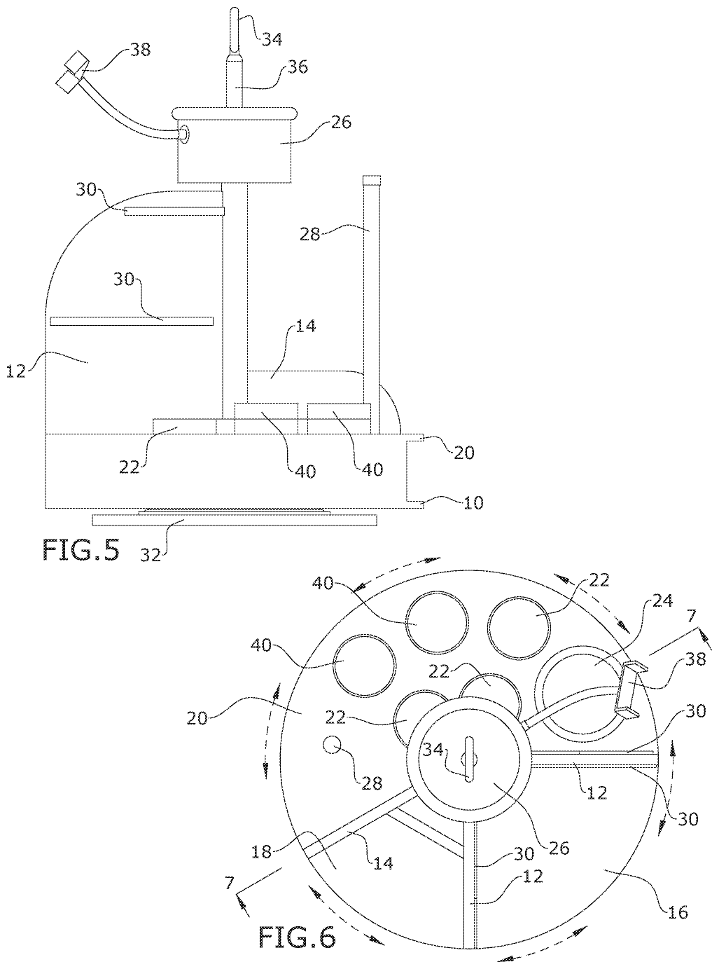

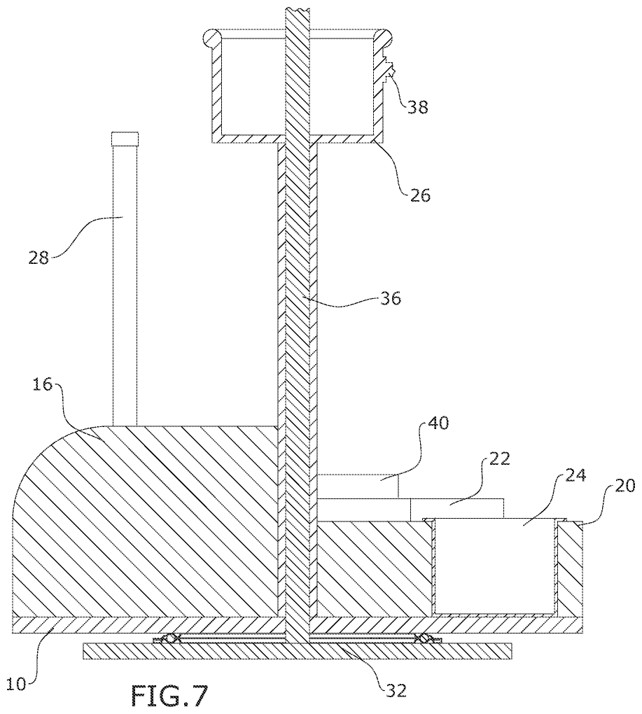

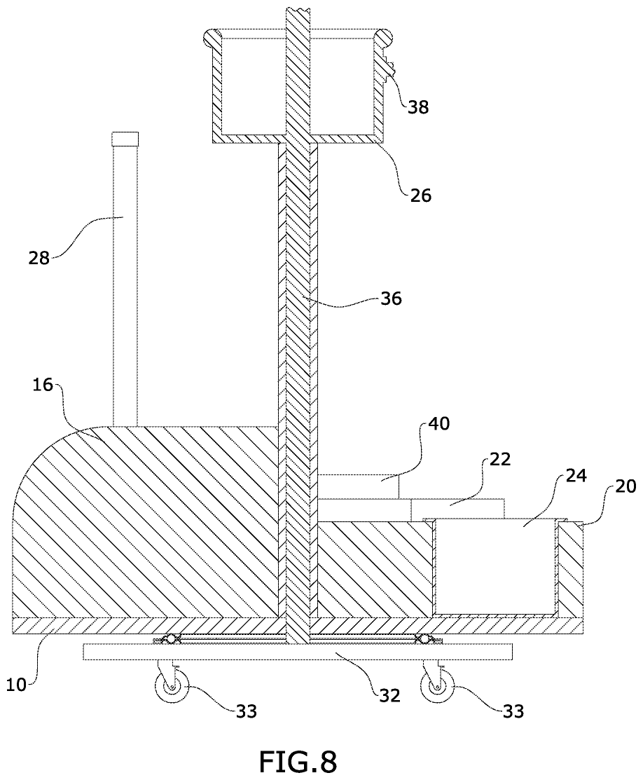

Referring now to the FIGS. 1-7, and as best seen in FIG. 1, the device of the present invention may store and organize hand tools 42, chemicals 44, a roll of paper towels 46, and a phone 48.

A rotatable, circular carousel 10 sits on top of a base 32. The carousel 10 includes a low shelf 16, a middle shelf 18, and a high shelf 20. The low shelf 16, middle shelf 18, and the high shelf 20 are separated by tall dividers 12 and a short divider 14. A center post 36 extends vertically from the base 32. The shelves 16,18, radiate circumferentially from the center post 36.

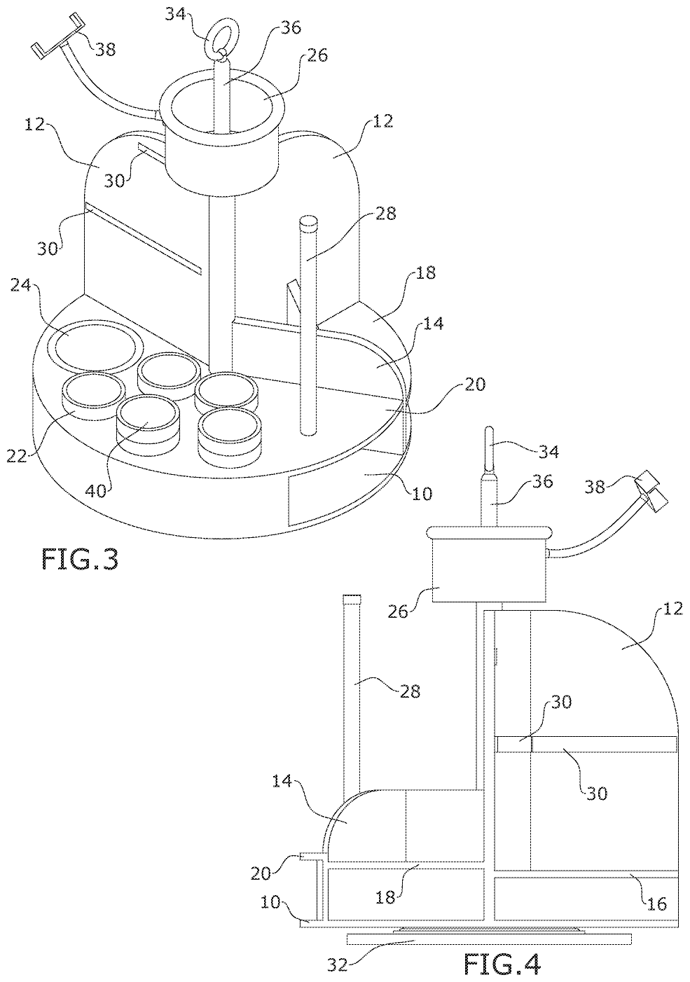

The high shelf 20 includes a large cup 24, small-part organizers 22, tall small-part organizers 40, and a vertical rod 28 (as best seen in FIG. 3 and FIG. 6). In some embodiments, the large cup 24, the small-part organizers 22, and the tall small-part organizers 40 are embedded into a shelf. The vertical rod 28 may be a paper towel holder, utilized for or operative to storing paper towels.

Magnetic strips 30 line a portion the tall dividers 12. The magnetic strips 30 may be affixed to the tall dividers 12 by an adhesive.

A top cup 26 sits near a top of the carousel 10, below a carrying ring 34. The top cup 26 has an aperture in its center. The center post 36 penetrates the aperture in the center of the top cup 26. The top cup 26 is joined to the carousel 10. In some embodiments, the top cup 26 is unitary with the carousel 10. In other embodiments, the top cup is joined to the center post 36 and does not rotate with the carousel 10.

A phone holder 38 extends from the top cup 26 via an arm.

It should be understood, of course, that the foregoing relates to exemplary embodiments of the invention and that modifications may be made without departing from the spirit and scope of the invention as set forth in the following claims.

1. A tool organizer comprising:
a rotatable platform mounted on a stationary base;
a non-rotatable post fixed to and extending vertically from a center of the stationary base and through a center of the rotatable platform;
at least one vertical divider radially extending from the non-rotatable post;
a first container fixed to the non-rotatable post so that the first container remains stationary as the rotatable platform rotates independently thereof;
a mobile phone holder extending from the container via an arm fixed to the first container wherein the mobile phone holder configured to accommodate a mobile phone that would remain stationary while the rotatable platform rotates; and
at least one horizontal shelf radially provided by the rotatable platform.

2. The tool organizer of claim 1, further comprising magnetic strips affixed to the at least one vertical divider.

3. The tool organizer of claim 1, further comprising a carrying ring at a top of the post.

4. The tool organizer of claim 1, further comprising a second container embedded in the at least one horizontal shelf and a paper towel holder extending from the at least one horizontal shelf.

5. The tool organizer of claim 1, further comprising at least one caster wheel affixed to a bottom of the supporting base.

6. The tool organizer of claim 1, further comprising at least one stationary foot protruding from a bottom the supporting base.

7. The tool organizer of claim 1, wherein the first container has an aperture in its center and the post penetrating said aperture wherein the first container is joined to the rotatable platform.

8. The tool organizer of claim 1, further comprising a light mounted on the rotatable platform.

9. The tool organizer of claim 1, wherein a height of the tool organizer is approximately 24 inches.

10. The tool organizer of claim 1, wherein a height of the tool organizer is approximately 12 inches.

11. The tool organizer of claim 1, wherein the rotatable platform has a diameter of approximately 18 inches.

12. The tool organizer of claim 1, wherein the arm of the mobile phone holder is integrated to a curved sidewall of the first container.

13. The tool organizer of claim 1, wherein each vertical divider is shaped so that the rotatable platform has a pyramidic shape for minimizing tipping hazards.

14. A method of using a tool organizer comprising:
selecting from a group consisting of: tools, materials, supplies, and a combination thereof;
placing the selection on a rotatable tool organizer with at least one horizontal shelf, at least one vertical divider, and a cell phone holder;
inserting a cell phone into the cell phone holder;
positioning the tool organizer in a location adjacent to a project; and
rotating the tool organizer for access to the selection when completing the project, wherein the cell phone holder is fixed to a stationary base of the tool organizer so that the cell phone holder does not rotate when the tool organizer is being rotated.

15. The method of claim 14, further comprising displaying from the cell phone an image for assisting a user with the project.

16. The method of claim 14, further comprising emitting audio from the cell phone.

17. A tool organizer comprising:
a rotatable platform mounted on a stationary base;
a non-rotatable post fixed to and extending vertically from a center of the stationary base and through a center of the rotatable platform;
a mobile device holder fixed to the non-rotatable post so that the mobile device holder remains stationary as the rotatable platform rotates independently thereof;
and
at least one horizontal shelf provided by the rotatable platform.

18. The tool organizer of claim 17, wherein the mobile device holder is configured to accommodate a mobile device that would remain stationary while the rotatable platform rotates.

19. The tool organizer of claim 17, wherein the mobile device holder extends from the non-rotatable post via an arm fixed thereto.

20. The tool organizer of claim 17, further comprising a container directly fixed to the non-rotatable post, and wherein the mobile device holder is integrated to the container.
